(19) United States
(12) Patent Application Publication
(10) Pub. No.: US 2017/0148125 A1
(43) Pub. Date: May 25, 2017

(54) SYSTEM AND METHOD OF TRANSPORTATION COORDINATION

(71) Applicants: Todd Ericksrud, De Pere, WI (US); Tammy Leurquin, De Pere, WI (US)

(72) Inventors: Todd Ericksrud, De Pere, WI (US); Tammy Leurquin, De Pere, WI (US)

(21) Appl. No.: 14/928,025

(22) Filed: Oct. 30, 2015

(51) Int. Cl. G06Q 50/28; G06Q 10/06

(52) U.S. Cl. CPC G06Q 50/28; G06Q 10/06312

(57) ABSTRACT

A transportation coordination system and method where exporters having items needing to be shipped, and importers having containers are optimally matched to reduce transportation costs and/or impacts. Multiple exporters and importers provide information about their shipping needs and timing requirements and the locations where those needs occur. Compatible or substitute containers, locations and/or ports may be defined. Compatible origins, destinations and equipment owners may also be defined. The information for exporters and importers is compared simultaneously to develop a global optimized solution for the movement of containers between origins, destinations, importers and exporters. The scheduled container movements may then be communicated to the equipment owners, importers and exporters who may have a chance to review and change the scheduled movements.

### BACKGROUND

Shipping containers used in the import and export process are the building blocks of global trade. However, empty container moves cost the industry an estimated USD 10 billion, annually. The problem is trucks deliver full containers to import customers and, once emptied, the containers are returned to the port, container yard or ramp. The containers sit empty until they are dispatched to an export customer to load the container and return it to the port for a second time. These additional trips lead to wasted time, expense and environmental pollution.

Street-turns, as illustrated and defined in FIG. 1, eliminate this waste by matching empty containers to exporters to load and then deliver the full container back to the port. Reducing empty moves and supply chain waste creates efficiencies for the importer, exporter, trucker, shipping line and rail line. However, the industry has struggled with how to execute optimal street-turns for decades. A non-exhaustive list of some of the common challenges include:
No single party has all the pieces of the street-turn puzzle
Parties with an import container do not know where export bookings are located
Parties with an export do not know where the import container supply is
Steamship lines and rail lines lose visibility to merchant haulage freight on their containers
Container size and type, chassis, rate negotiations, trucker interchanges and steamship line reuse approval further complicates street-turns
Internal and closed solutions have limitations; these systems do not contain all the market data necessary to evaluate optimal solutions
Evaluating container supply and demand information is overwhelming for the parties involved—steamship lines, rail lines, ports, dates, time, distance, shipper preference, free days, etc.
Assessing various scenarios is difficult, timely, cost prohibitive and, more times than not, impossible to evaluate manually
Numerous and non-standard communication methods between industry stakeholders like email, phone and spreadsheets
Planners are overwhelmed by their complex day-to-day activities and have little time to create street-turns

Successful execution of street-turns requires cooperation of five fundamental processes. These processes are all practiced today and represent the current state of the industry. Examples include:
Neutral Provider—Impartial party to street-turn
Open Network—Open to anyone willing to subscribe
Collaboration Platform—Work with all stakeholder groups
Container Intelligence—Track location and size/type variables of supply and demand units
Automated Street-turns—Software finds matches and executes street-turns for supply and demand units, without the need for vendor intervention
   Industry participants that practice some of these processes include:
Load Board—Systems that display suppliers who have cargo and those who can move the cargo—no Container Intelligence; cannot automate street-turns
Solutions Operator—Operating company that focuses on street-turns; similar to a Broker model—not a Neutral Provider; works with limited data
Transportation Management System (TMS) Provider—Concerned with transportation operations and route optimization management—Neutral Provider who can automate street-turns; limited in all other areas
Broker—Third-party that provides needed logistical functions for a cost—operates in an Open Network on a Collaborative Platform; limited in all other areas

These participants work within the supply-chain, and while they all perform one or more of the fundamental processes required of optimal street-turning, no participant actively manages all five. Furthermore, none of these participants attempt to tackle any of the larger industry goals that have eluded the logistics industry for decades. These desirable improvements include:
Global Optimization—Branch of applied mathematics and numerical analysis that deals with the global optimization of a function or a set of functions according to some criteria
Match Guidance—Applying matching logic to a customer's supply and/or demand data, and presenting customized matching solutions based upon preferences and feasibility
Engage Ecosystem—Common platform collaboration between our customer, vendors, and their customers that is mutually beneficial to all parties within the supply-chain
Turnkey SaaS—Configuration and data translation mapping that requires little or no systems integration, yet is automated

As it stands today, industry participants struggle to execute optimal street-turns because they have not found a solution that allows them to effectively manage all five of the fundamental components of street-turning. Moreover, the industry as a whole has not devised a way to achieve the larger goals of the street-turn process. The strategy outlined in this document illustrates a system that consolidates all the fundamental processes and desired improvements of optimal street-turning, revealing a comprehensive solution to optimal street-turning—a problem that is far more complicated than it appears.

The conventional approach to the orchestration and coordination of movements of containers typically includes:
1. Exporter has a Demand load that must get to the Port.
2. Exporter analyzes a detailed spreadsheet; observes that Importer will be traveling near the Export Location on their way back to the Port.
3. Exporter contacts Importer by phone; requests to match (street-turn) with Importer.
4. Importer considers Exporter's request; begins negotiations with Exporter.
5. Both parties agree to terms; the street-turn is initiated.
6. Importer drops off Supply load at the Import Location then travels to Export location to pick up Demand load.
7. Importer takes the Exporter's Demand load back to the Port, completing the street-turn.

This is not a global solution to all of the container movement needs of a particular location or community, and does not permit optimization of such movements to reduce waste and environmental impacts.

While the above background is written with reference to standardized shipping containers, it is understood that these same problems occur in other segments of the transportation industry, such as but not limited to:
Standard air transportation containers
Container chassis
Rail vehicle transportation
Automotive industry logistics
Oil and gas logistics
FMCG pooling
Pallet returns
Domestic big box and intermodal
Container/trailer planning and pooling

Improvements to these conventional approaches for managing and coordinating the movement and use of shipping containers are desirable.

### BRIEF DESCRIPTION OF THE DRAWINGS

The accompanying drawing figures, which are incorporated in and constitute a part of the description, illustrate several aspects of the present disclosure and together with the description, serve to explain the principles of the present disclosure. A brief description of the figures is as follows:

FIG. 1 is a diagram illustrating and defining a term street-turn as used within this application and in the shipping industry.

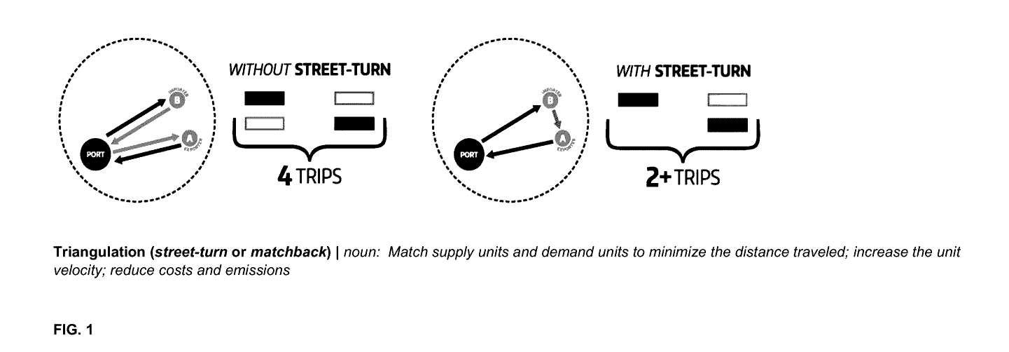

FIG. 2 is an overview diagram of the transportation planning and coordination system of the present disclosure.

FIG. 3 is a detailed view of a customer configuration subunit of the system of FIG. 2.

FIG. 4 is a detailed view of a data subunit of the system of FIG. 2.

FIG. 5 is a detailed view of a matching engine subunit of the system of FIG. 2.

FIG. 6 is a detailed view of a display subunit of the system of FIG. 2.

FIG. 7 is a detailed view of a data subunit of the system of FIG. 2.

FIG. 8 is a detailed view of a data subunit of the system of FIG. 2.

### DETAILED DESCRIPTION

Reference will now be made in detail to exemplary aspects of the present disclosure which are illustrated in the accompanying drawings. Wherever possible, the same reference numbers will be used throughout the drawings to refer to the same or like parts.

### System Efficiency

Numerous inefficiencies and inadequacies exist in the import and export process. When street-turns are not utilized, these inefficiencies include, but are not limited to:
Empty containers are expensive|Every year Maersk Line spends nearly USD $1 billion related to the shipping of more than 4 million empty dry and reefer containers back to where customers need them. Through more strategic use of its equipment, Maersk Line is reducing the costs of this imbalance.—By John Churchill, A. P. Moller—Maersk¹ ¹http://gcaptain.com/filling-shippings-billion-hole/
Shipowners allocate their containers to maximize their revenue, not necessarily the economic opportunities of their customers. In view of trade imbalances and of the higher container rates they impose on the inbound trip for transpacific pendulum routes, shipowners often opt to reposition their containers back to Asian export markets instead of waiting for the availability of an export load. For instance, while a container could take 3 to 4 weeks in the hinterland to be loaded and brought back to the port and earning an income of about $800, the same time can be allocated to reposition the container across the Pacific to generate an return income of $3,000.
   Transport companies must cope with access and storing charges at terminals as well as wear and tear on equipment.
   Truck drivers are losing hours waiting to access terminal gates and distribution centers to return empty containers and chassis.
   Terminal operators lose productivity because of congestion and are facing pressures from localities to reduce the number of idle trucks at their gates.
It was assessed that the share of containers returning full to a terminal without initially been picked up empty from that terminal or a depot would shift from 2 to 10% if a virtual container yard was used. Thus, repositioning strategies are important in the management of containerized assets, but effectiveness is a difficult goal to achieve.² ²https://people.hofstra.edu/geotrans/eng/ch5en/appl5en/ch5a3en.html
System-wide logistics and efficiency improvements can be an effective way to reduce truck traffic and pollution, but these benefits are difficult to quantify.
   Virtual Container Yards are online managements systems that connect trucking companies that have empty containers with those nearby who could use them, which reduces empty container transport. Several studies have estimated that up to 10 percent of container truck traffic could be reduced in Southern California by 2020 with the use of VCYs.
   The City of Fukuoka in Japan reported a 67 percent reduction in freight trips and 87 percent reduction in freight miles on the road after taking a centralized approach to consolidating and managing logistics of urban delivery and freight traffic.³ ³http://www.ccair.org/uploads/3/0/5/4/30543452/moving_california_forward_executive_summary_{—} final.pdf
Currently, industry estimates are that carriers can save about $200 per street-turn by using a VCY. And, once these systems become institutionalized, the potential for greater savings arises—including savings that extend to shippers.
   A trucker and an ocean carrier, for example, may determine that, based on their general import and export flows to one area, a certain type of ongoing street-turn arrangement makes sense.
   “They realize they can all benefit—by taking that extra load, the trucker receives 150 percent of the round-trip rate, while the ocean carrier and shipper each pay 75 percent of what they would have paid, and reduce their current haulage expense by 25 percent each,” he explains.⁴ ⁴http://www.inboundlogistics.com/cms/article/virtual-container-yards-net-real-results/When

When optimal street-turns are incorporated into the import and export process, a significant percentage of these multiple inefficiencies are immediately improved. Examples of the efficiencies to be gained through optimized selection of street-turns include but are not limited to up to 30% reduction in port congestion (permitting more efficient port operation and greater cargo handling with existing facilities), fewer drivers on the road (reducing road congestion, vehicle emissions, the number of drivers and tractors needed), fewer miles driven per cargo movement (reducing transportation costs), and a resultant reduction in vehicular emissions of up to and more than 30%.⁵ ⁵Matchback Systems data and primary research

### DEFINITIONS

### Glossary of Terms

CY (Container Yard)—a facility where cargo containers are transshipped between different transport vehicles, for onward transportation
VCY (Virtual Container Yard)—a means of developing a shared resource information system to match empty equipment needs through the adoption of next generation internet and new technology information platforms
3PL (Third-party logistics provider)—also known as a non-vessel operating common carrier (NVOCC), is a firm that provides service to its customers of outsourced (or “Third Party”) logistics services for part, or all of their supply chain management functions
FF (Freight Forwarder)—a person or company that organizes shipments for individuals or corporations to get goods from the manufacturer or producer to a market, customer or final point of distribution
Integrator—non-asset logistics company, like a 3PL, NVOCC, IMC or freight forwarder, that coordinates transportation
SSL (Steamship Line)—a firm providing passenger and or cargo transport services that are scheduled with its own vessels or leased vessels
BCO (Beneficial Cargo Owner)—refers to an importer that takes control of their cargo at the point of entry and does not utilize a third party source like an NVOCC or Freight Forwarder
IMC (Intermodal Marketing Company)—IMCs purchase rail and truck transportation services, utilize equipment from multiple sources, and provide other value-added services under a single freight bill to the ultimate shipper.
Dray—any vehicle, such as but not limited to a truck, used to haul goods, especially one used tocany heavy loads
NA (North America)
Domestic—in shipping, refers to “in-country” (i.e. North America)
FMCG (Fast-moving Consumer Goods)—consumer packaged goods (CPG) are products that are sold quickly and at relatively low cost
Importer—includes any person or entity including proxies who might be able to supply a container.
Exporter—includes any person or entity, including proxies who might need a container, including but not limited to yards and container pools.

### Participants—Customer Segmentation

| | |
|---|---|
| Shippers - Importers & Exporters | Both |

1. Multiple steamship lines
2. Familiar with matchback (street-turn) concept
3. Operate direct and with 3PL/FF model
4. Value strategic alliance/competitive advantage
5. Price driven and place value on access to the box
6. Market intel differentiator; spot market driven-SSL, market,
volume, etc.

| | |
|---|---|
| Steamship Lines | Match Advisor |

1. Significant NA dray infrastructure
2. Only control door containers inland
3. Significant value by reducing cost to match, repositioning and increase
container velocity

| | |
|---|---|
| Providers - Truckers, IMC, NVOCC, Broker | Match Density |

1. Looking for matching freight with specific SSL box
2. Split with access via web, and resident platform

| | |
|---|---|
| Integrators - Freight Forwarders, 3PL's | Both |

1. Door-to-door service providers
2. Numerous opportunities for value creation
3. Significant infrastructure to manage

### Gale and Shapely

Created in 1962, the Gale and Shapely algorithm has been utilized to solve a variety of practical problems including matching partners for marriage, matching students and high schools in New York City, matching kidneys and patients, and helping to match new doctors with national residency programs. More recently, in 2012, Lloyd Shapley along with Alvin E. Roth won a Noble Prize for the Theory of Stable Allocations and the Practice of Market Design.

Gale and Shapely is a remarkably flexible algorithm that can be adapted to matching problems that are both obvious and obscure. For decades the logistic industry has struggled to manage the inefficiencies of the import and export process. While it's been around for over 50 years, no one has thought to apply the Gale and Shapely matching algorithm to the complex problem of matching import and export units.

Algorithm

```
function stableMatching {
  Initialize all m ε M and w ε W to free
  while ∃ free man m who still has a woman w to propose to
{
    w = highest ranked woman to whom m has not yet
proposed
    if w is free
      (m, w) become engaged
    else some pair (m′, w) already exists
      if w prefers m to m′
        (m, w) become engaged
        m′ becomes free
      else
        (m′, w) remain engaged
  }
}
```

Not only is this algorithm and associated approach being used in a unique way within the present disclosure, but based on the type of user, the preference stated with the Gale and Shapely algorithm may be altered for a particular user or customer depending on where that user or customer is in the environment. For example, an importer may view a movement schedule developed with the algorithm so that the movements are optimized from an importer point of view or lens while an exporter may view the movements that have been optimized from an exporter point of view or lens. This allows the user to receive the best results based on their lens. In the future, it is anticipated that the system and method of the present disclosure may assist users by allowing the use of multiple lenses and utilizing the algorithm to harmonize all users, independent of the lens (import or export).

In mathematics, economics, and computer science, the stable matching problem (SMP) is the problem of finding a stable matching between two equally sized sets of elements given an ordering of preferences for each element. A matching is a mapping from the elements of one set to the elements of the other set. A matching is stable whenever it is not the case that both:
a. Some given element A of the first matched set prefers some given element B of the second matched set over the element to which A is already matched, and
b. B also prefers A over the element to which B is already matched

In other words, a matching is stable when there does not exist any match (A, B) by which both A and B are individually better off than they would be with the element to which they are currently matched.

The stable matching problem has been stated as follows:
Given n imports and n exports, where the matching logic has ranked all in order of preference (shortest distance, distance save, in-route), pair the imports and exports together such that there are no other pair is better.

Note that the requirement that the matches be one import and one export distinguishes this problem from the stable matches problem.

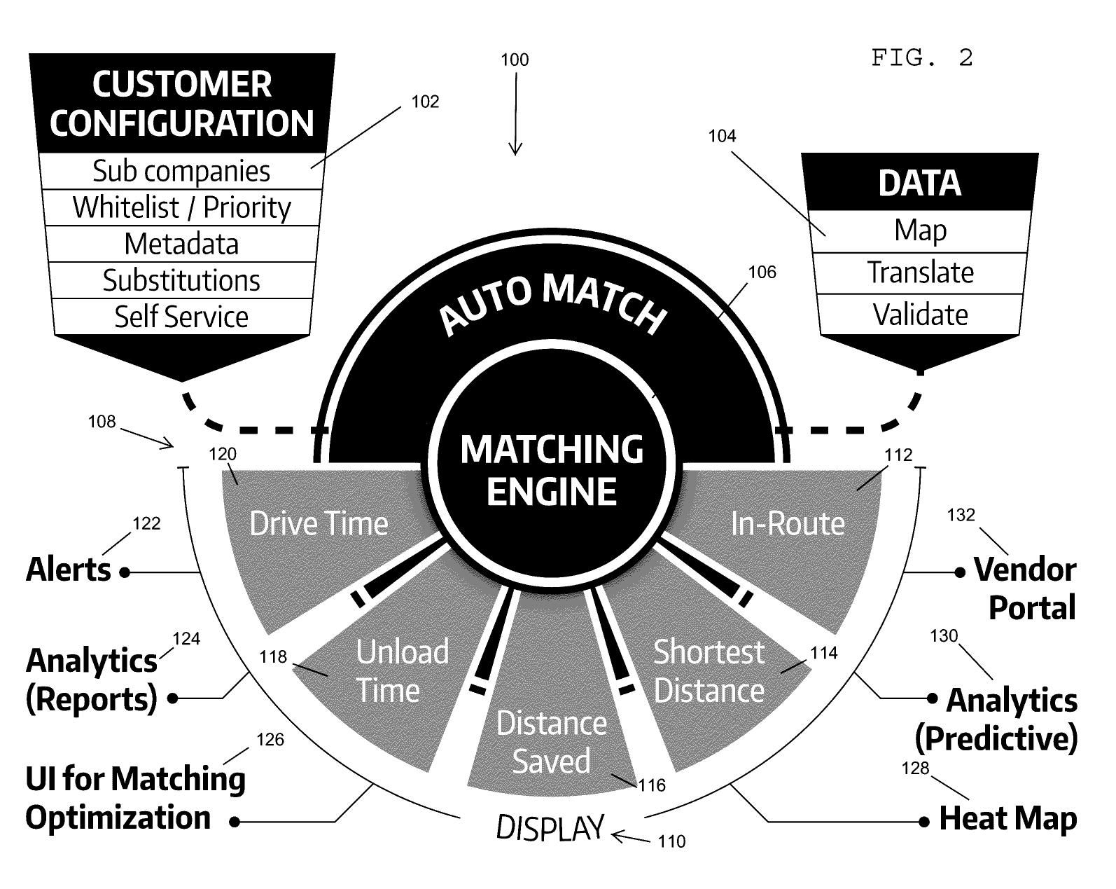

Referring now to FIG. 2, a transportation planning and coordination system 100 according the present disclosure may include some or all of:
a customer configuration subunit 102 where information about a specific individual or company wanting to send or receive goods in standardized shipping containers may be input, gathered or translated from existing datasets;
a data subunit 104 where information regarding the companies or individuals wishing to send or receive goods in standardized shipping containers may be converted into a compatible format and married with other information regarding the environment;
a matching engine subunit 106 where the information regarding all of the companies or individuals wishing to receive or send goods in standardized shipping containers is matched and an optimized list of pairings of street-turns is generated;
a match optimization functions subunit 108 where the matches generated in the matching engine may be viewed and/or optimized with regard to a variety of possible analytic tools based on specific company or individual business drivers;
   an in-route analytics subunit 112 where the matches generated may be viewed and/or optimized with regard to prioritizing in-route transportation;
   a shortest distance subunit 114 where the matches generated may be viewed and/or optimized to provide the shortest aggregate distance traveled by the standardized shipping containers and the vehicles transporting these containers;
   a distance saved subunit 116 where the total distance saved by the matching optimization may be viewed and/or maximized with regard to a conventional or suboptimal matching approach;
   an unload time subunit 118 where the total time available for the companies or individuals sending or receiving goods in standardized shipping containers may be viewed, set, altered or deleted;
   a drive time subunit 120 where the total time that the standardized shipping containers will be in-transit when being moved between a receiving company or individual (such as but not limited to an importer) and a sending company or individual (such as but not limited to an exporter), may be viewed, set, altered or deleted;
a display and feedback loops subunit 110 where customers may view and/or alter the matches generated;
   an alerts subunit 122 permits customers to set triggers or certain parameters or individualized requirements and receive alerts when a match generated by system 100 exceeds any of these triggers or parameters;
   an analytics (reports) subunit 124 where a customer or concerned regulatory body may view standardized reports for the matches generated, the impact of these matches, or create specialized or custom reports as needed;
   a user interface for matching optimization subunit 126 where a customer may modify parameters for matching with regard to the standardized shipping containers they may receive or send upon viewing the posts or transport orders, any alerts, or which may come about due to rapidly changing business requirements;
   a heat map subunit 128 where clusters of movements, street-turns, or transportation routes may be viewed and analyzed. Such clusters may include but are not intended to be limited to:
      import posts from customers,
      export posts from customers,
      summarized import posts from all customers,
      summarized export posts from all customers,
      customers potential pairs,
      containers by locations or equipment owner or size/type, and
      any customer and/or summarized analytics may be viewed;
   an analytics (predictive) subunit 130 where customers and other concerned parties or regulatory bodies may forecast future impacts of use of the matching system of the present disclosure as well as possible future transportation needs or impacts based on historical shipping patterns or assumptions;
   a vendor portal 132 where service providers or vendors who might not customers of the system according to the present disclosure but which are impacted by the optimization and matching may be provided access to the data that may impact the services these vendors provide to the customers of the system.

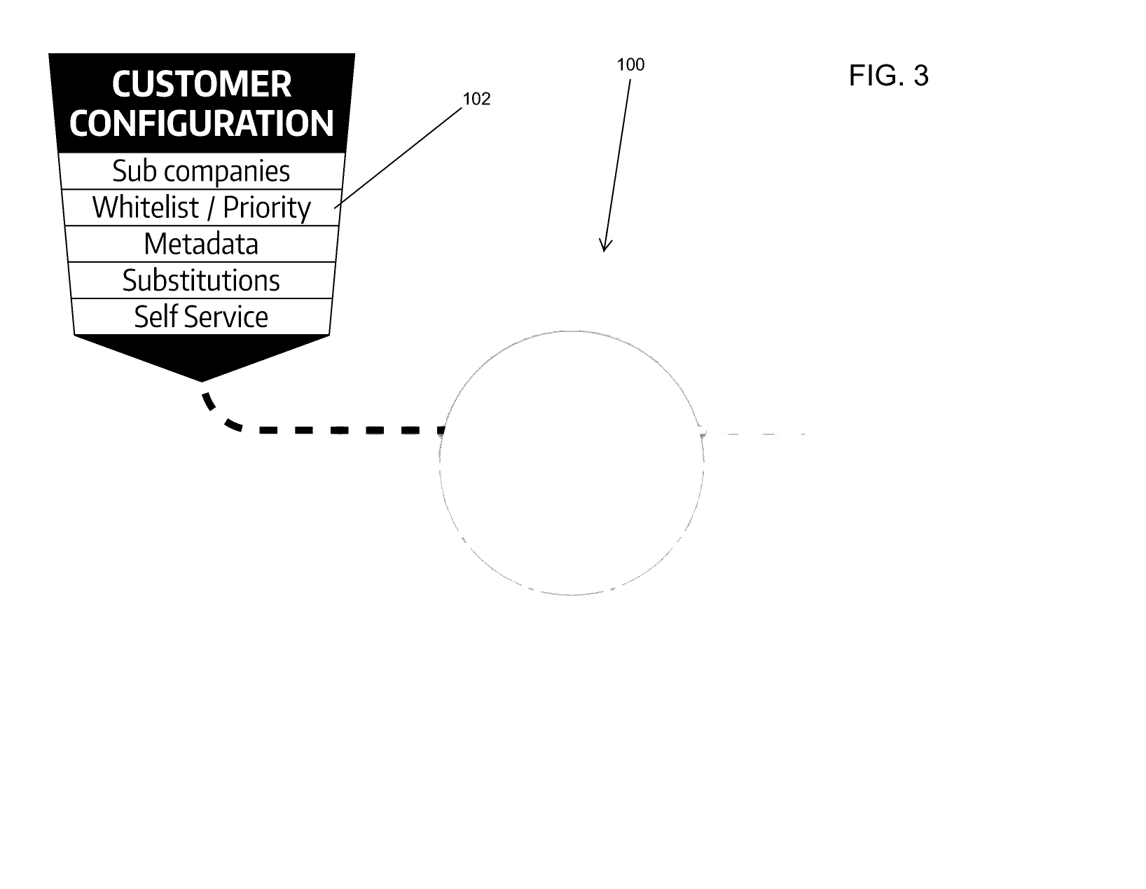

Referring now to FIG. 3, the customer configuration subunit 102 of transportation planning and coordination system 100 includes a general process that is customized for each customer. Business requirements and technical specifications dictate how customer data is configured and allows system 100 to be used to generate match results that are tailored to each individual customer. Customers may input or provide for input information regarding any affiliated companies or subsidiaries that might impact preferences within the matching process. Customers may be able to itemize or set priorities where some movements of containers may be designated as more or less critical than others. Customers may also provide additional metadata for each shipment or company, such as but not limited to metadata regarding characteristics or weights of the goods to be moved, order numbers (internal or external), special notes or instructions, or anything else that the customer(s) deem important enough to be tied to the movement request, as well as priorities or preferences with respect to specific company, origin and destination locations. It is preferable though not required that this subunit include a mechanism for customers to enter their particular business rules that may help determine the best and most acceptable match among the other available container supply or container need. Such rules may include preferences for matches with existing businesses partners or subsidiaries, requirements for associations with specific equipment owners or other companies if available. White lists allow a customer to identify which companies they will and will not coordinate with for street-turns

In this subunit, customers may also be able to provide information about compatible substitutions that may be possible to aid the matching process. Such substitutions may include but are not limited to the size and type of standardized shipping container, preferred transportation providers for moving the container(s) into or out of their facility, or transportation providers who are not preferred or permitted to move containers into or out of their facility, preferred, permitted or prohibited steamship lines or container owners, ranges of dates and times if specific dates or load timing are more flexible, among others.

It is anticipated that customers may either provide the data to the operator of transportation planning and coordination system 100 or may utilize a self-service portal to enter compatible data regarding their company information, shipping needs, priorities and possible substitutions directly into system 100. The system and method of the present disclosure may be used to provide a Software as a Service to which customers may contract, or the system may be potentially be offered as an off-the-shelf or customized solution which may be used as a standalone product or incorporated into the systems, products or IT infrastructure of another party.

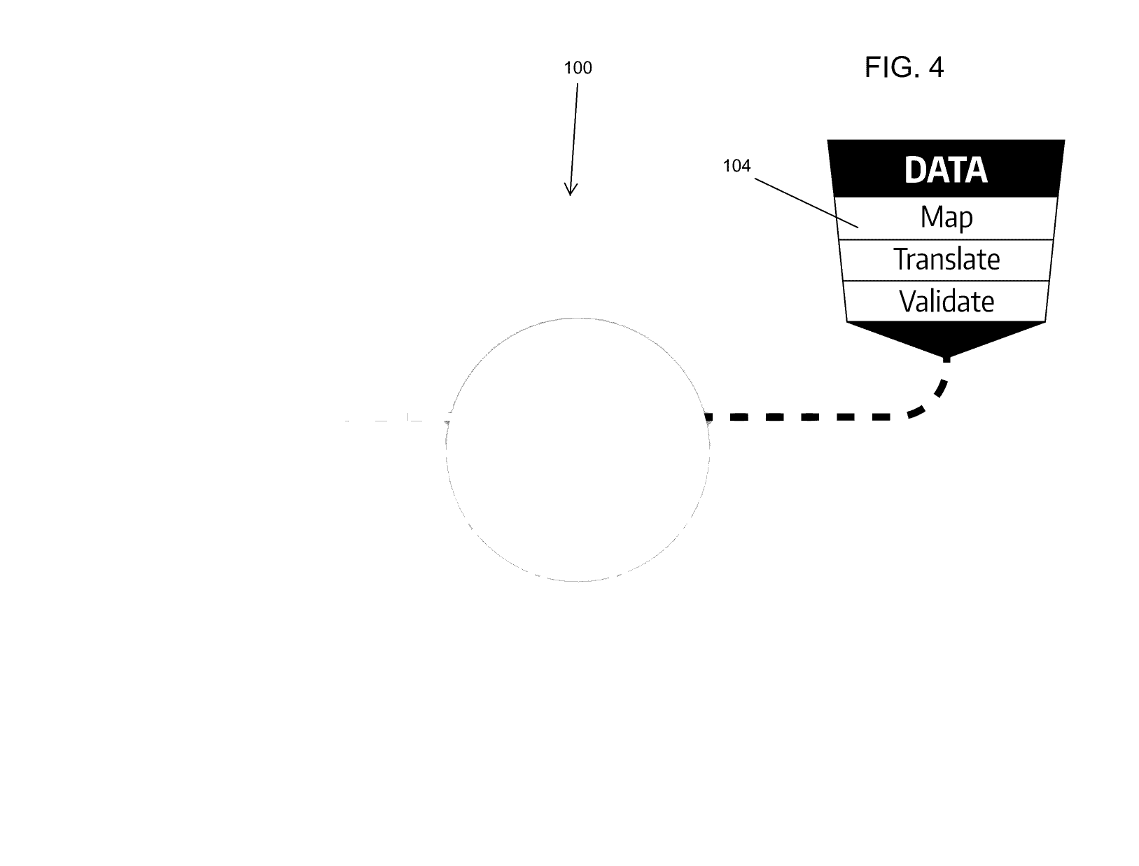

Referring now to FIG. 4, the data subunit 104 of transportation planning and coordination system 100 includes a set-up process that translates a customer's existing data into data that can be worked within system 100. After the initial set-up is complete, a validation process occurs each time the customer sends their data, ensuring their translated data is free of errors before being imported into and matched within system 100. A desired component of this data subunit will be to ensure that mapping of the locations where containers will be located or needed, the surrounding transportation infrastructure and any regulatory requirements or limitations for movement within that environment for each movement or customer are accurately captured and included within the dataset used by system 100.

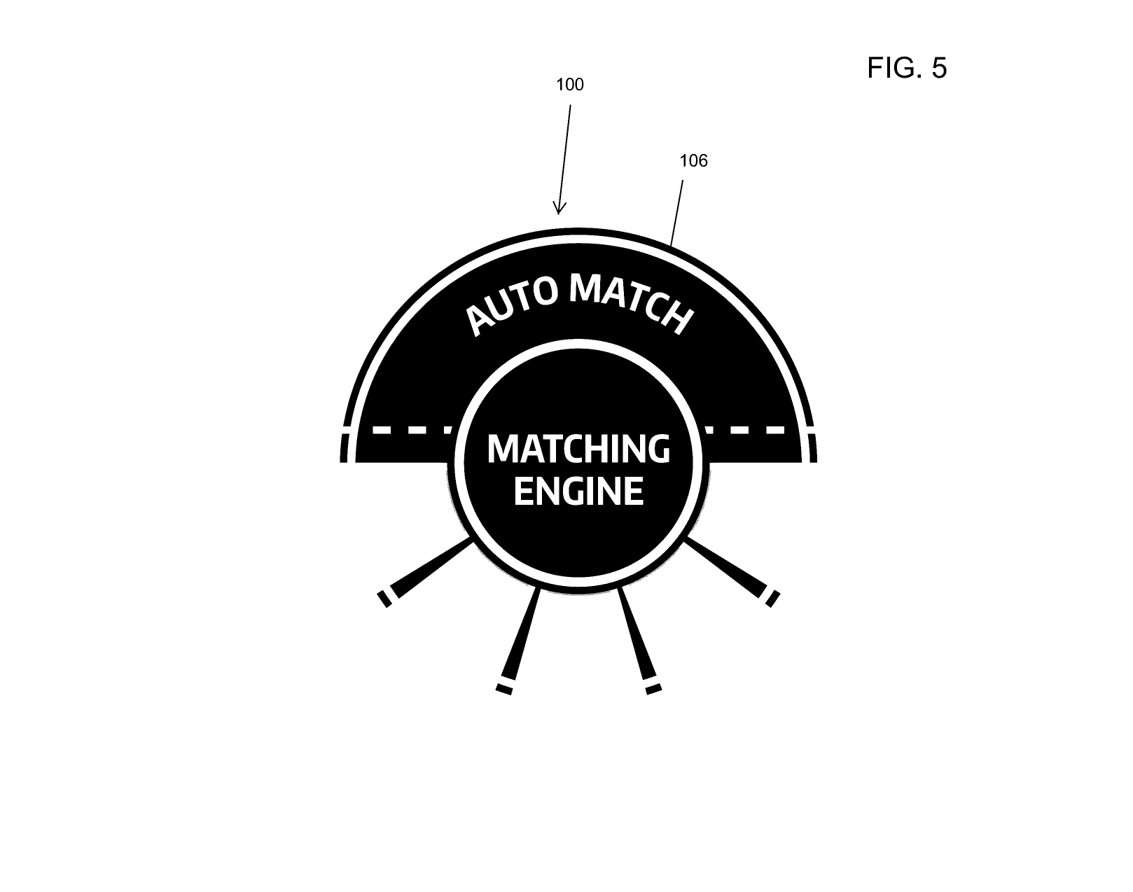

Referring now to FIG. 5, the matching engine subunit 106 of transportation planning and coordination system 100 includes an automated process that analyzes translated customer data and displays match planning advice that is tailored for each customer. Once the data for all customers has been entered and validated, matching engine 106 of transportation planning and coordination system 100 will then perform a global solution for all container movements within this dataset. This initial global solution may optimize the movement of containers from origins and steamship lines to companies or individuals receiving goods in standardized shipping containers, the movement of these containers from receiving companies or individuals to shipping companies or individuals, and the movement of these containers from shipping companies or individuals to destinations for further movement, such as but not limited to movement by steamship lines.

The dataset may include container requirements for one or more shipping customers as well as one or more receiving customers. Some datasets and global solutions may be for single companies with massive or complex container movement requirements seeking to optimize their internal container movements and logistics. Other datasets and global solutions may include a plurality of shipping customers and receiving customers, where each customer has need for one or more container movements.

Alternatively, a dataset and global solution may be focused on the optimization of all container movements into and out of a single port, encompassing all movements from any steamship lines out of the port and into the port to the steamship lines. This may encompass one or a plurality of steamship lines, one or a plurality of transportation providers moving the containers, and a plurality of companies or individuals needing containers moved to or from their locations.

A dataset and global solution may be for a single equipment operator and may encompass container movements from a single origin and to a single destination, or may optimize and coordinate movements for this equipment operator with respect to a plurality of origins and destinations. Alternatively, a plurality of equipment operators may coordinate their container movements from a single origin and destination, or with respect to a plurality of origins and/or destinations.

As a further alternative, service providers or vendors, such as but not limited to container transportation companies, may be included in the dataset and the global solution generated by the system of the present disclosure or may be considered in the set of customers for this system.

It is anticipated that any number of combinations of the nature of the various participants in this container planning and movement process is possible and it is not intended to limit the scope of this disclosure with the foregoing illustrative examples. It is anticipated that the global solutions generated by the system of the present application may encompass but not be limited to steamship lines, container transportation or movement providers (trucking companies), receiving customers, shipping customers, ports, port authorities, government agencies or regulatory bodies, industry groups, unions, business consortia or partnerships, software companies, logistics companies, service providers in this industry or in related industries, or any subset or combination thereof.

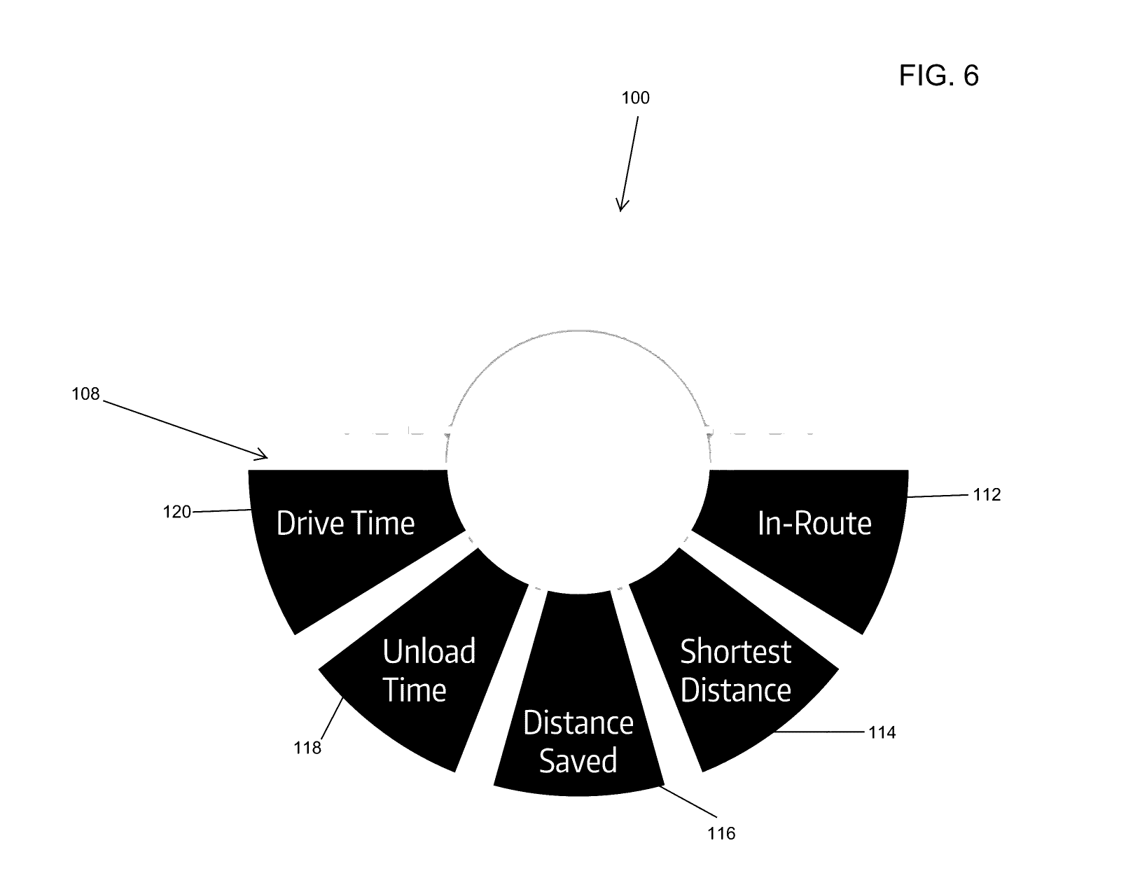

Referring now to FIG. 6, the match optimization functions subunit 108 of transportation planning and coordination system 100 may include an expanded feature where customers subscribed to system 100 may be able to review, confirm and potentially alter potential matches generated by matching engine subunit 106 in a global solution. Customers may view the global solution or the subset of the global solution that applies specifically to their container movements or needs. The various tools or visualizations for viewing the global solution may include analysis of in-route characteristics of the movement of containers (using in-route analytics subunit 112), analysis of the total driving distance covered to move the containers included within the global solution (using shortest distance subunit 114), the total distance saved by use of the optimized global solution compared to other planning and matching approaches (using distance saved subunit 116), incorporating the window of time available for the customers to unload and/or load containers received before the container is scheduled to be moved (using unload time subunit 118), and incorporating the total drive time scheduled for the movement of containers (using drive time subunit 120), based on the optimized global solution or any subset or combination thereof. Other subunits may be added to the system and method of the present disclosure within the scope of this inventive concept that may add additional modes of optimization for movements of containers and which may be used as ancillary, primary or secondary alternative solutions to create or modify the initial global solution.

These modes of optimization subunits within match optimization subunit 108 provide customers or other interested parties to visualize the impact of the global solution provided by the system and method of the present disclosure on the movement of containers. While the system of the present disclosure is intended to develop an initial optimized solution based on the data entered by the customer(s), there may be tweaks or alterations of this solution if there is a desire to optimize the solution using one of these subunits as a primary driving determination factor in the solution. The initial optimized global solution may balance the various approach to develop a solution that may not be optimal based on any one of these subunits 112 to 120. Then, if desired, a customer may choose to have a global solution optimized based on one of these subunits emphasis.

For a non-limiting example, consider that a particular customer may need to optimize the global solution so that the total distance travelled by trucks moving the containers is minimized, possibly at the expense of in-route characteristics or total driving time. This customer may be able to view the initial global solution to see the total distance traveled by trucks moving containers and then recompute the global solution to optimize reduction of distance travelled. Alternatively, a customer may wish to alter the initial global solution to minimize drive time at the expense of distance travelled. Other customers may need to alter the initial global solution to emphasize unload or movement timing.

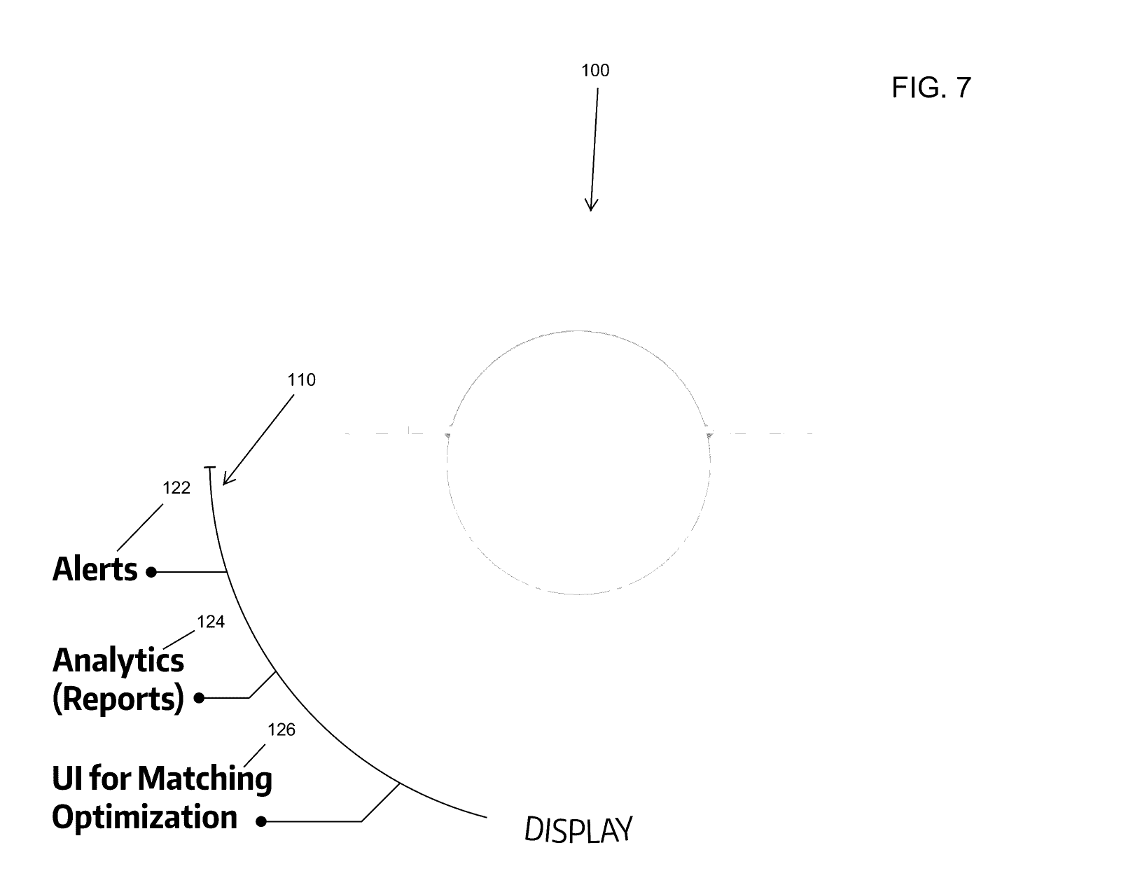

Referring now to FIG. 7, a first portion of the elements within display and feedback loops subunit 110 of transportation planning and coordination system 100 includes alerts subunit 122, analytics (reports) subunit 124 and user interface for matching optimization subunit 126. The general operation of these subunits was described above, but in combination, these subunits together permit customers to visualize the initial global solution by highlighting matches within that solution that might be outside of some preset desired parameters, reporting general and specific characteristics of the initial global solution and providing an interface to permit tweaking or optimization of the initial global solution based on one or more specific subunits within match optimization functions subunit 108, as described above.

The operation of user interface for matching optimization subunit 126 may also serve to create an automated, virtual environment where customers can view and create posts regarding the initial global solution, send and receive match requests, and accept, confirm and reject match requests that may be included in the initial or modified global solution.

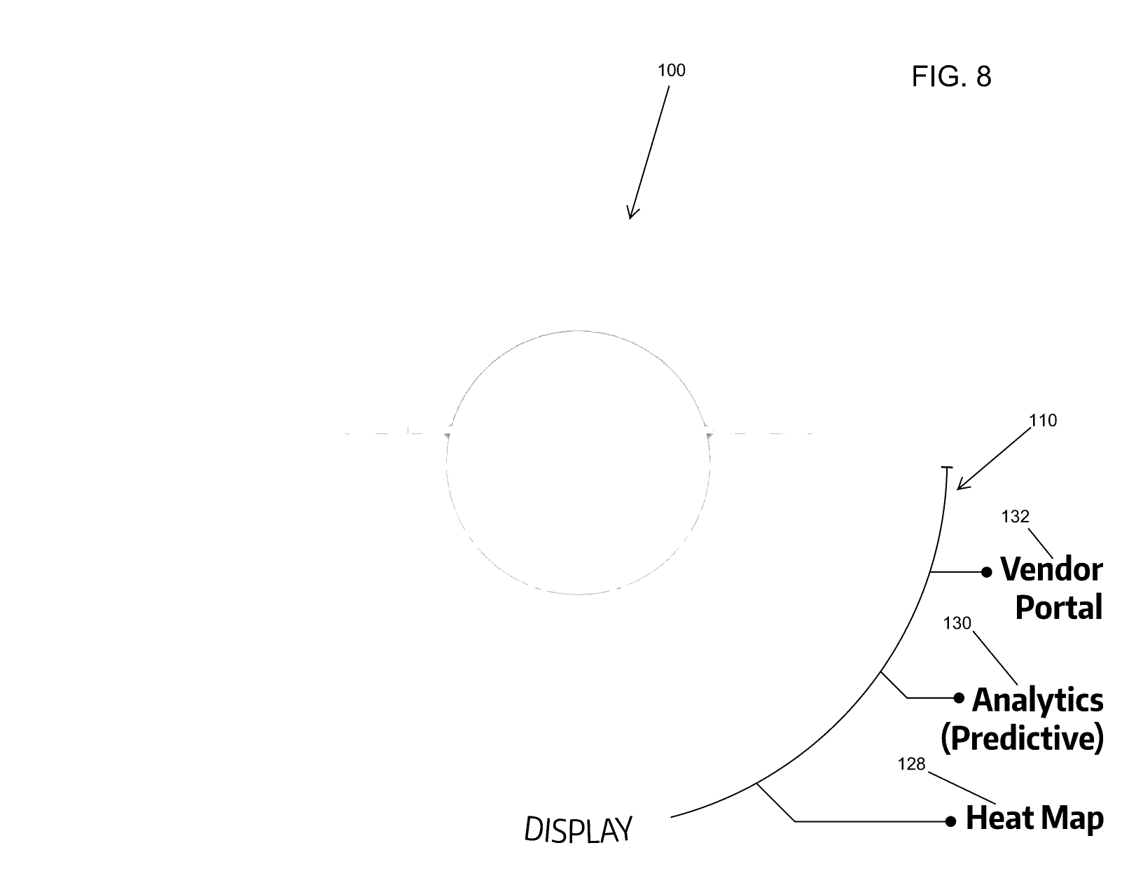

Referring now to FIG. 8, a second portion of the elements within display and feedback loops subunit 110 of transportation planning and coordination system 100 includes graphically displayed analytics and visualizations based on a customer's current and historical data. Heat map subunit 128 generates displays where clusters of movements, street-turns, or transportation routes in the initial or amended global solution or in all or a portion of the customer's information may be visualized, viewed and analyzed. These clusters may include: import posts from customers, export posts from customers, summarized import posts from all customers, summarized export posts from all customers, customer potential pairs, containers by locations or equipment owner or size/type, and any customer and/or summarized analytics may be viewed. Analytics (predictive) subunit 130 may provide customers and other concerned parties or regulatory bodies with forecasted future impacts of use or non-use of the matching system of the present disclosure, as well as possible future transportation needs or impacts based on historical shipping patterns or assumptions based on future transportation needs and infrastructure.

Vendor portal 132 may provide access to the global solution to service providers or vendors who might not be not customers of the system disclosed herein. These vendors may be impacted by the optimization and matching in the global solution or may be tasked with carrying out the movements in the global solution, so that the global solution may impact the services these vendors provide to the customers of the system. Extractable, downloadable and printable reports may also be available to these vendors.

The following tables illustrate and highlight differences between the conventional approach to planning of container movement and the improved system and process for developing a global optimized solution for these movements.

| Conventional Street-turn Process | Manual |
|---|---|
| 1. Prioritize work | |

2. Call your network of importers, exporters or equipment owners

3. Discuss opportunity for interest over the phone or email
4. Negotiate
5. Manually review options
6. Select matches with no decision support
7. Confirm agreement
8. Manually update your system

| Process according to present disclosure | Automated/Online |
|---|---|
| 1. Electronic data load | |

2. Review potential matches - User preferences, sorts and filters

3. Select optimal matches to request and negotiate
4. Confirm matches

5. Matchback (street-turn) electronically sent to dispatch system
in User's format

| | |
|---|---|
| Process according to present disclosure | |
| With Auto Match | Automated/Online |

1. Electronic data load; automatically match internal Supply/Demand

2. Confirm optimal matches

3. Matchback (street-turn) electronically sent to dispatch system
in User's format

In the tables below, the various participants in the transportation industry are listed to illustrate which of the participants may be most positively impacted through the application of the system of the present application to the planning and coordination of freight and container movements, as described herein. Other participants may also benefit from the application of the system of the present application and it is not intended to limit in any way the possible benefits of the use of such a system to just these participants. The operation of the system of the present application may further provide tremendous benefits to others not listed as participants, such as but not limited to downstream consumers who may experience reduced prices due to lowered costs and improved efficiencies in the transportation process, as well as environment, which may be improved through the reduction of emissions as well as other benefits of fewer vehicles on the road and better use of existing transportation infrastructure rather than the expansion of this infrastructure.

MATCH DENSITY
Matching Outside

Importers
Exporters
Truckers
BCO
IMC
Brokers
Freight Forwarders
3PL
Associations/Groups
Software Companies

MATCH ADVISOR
Matching Inside

Importers
Exporters
Truckers
Freight Forwarders
3PL
SSL
Associations/Groups
Software Companies

### Matching Logic

To create a valid potential match the following criteria must be satisfied:
1. One post is an Import and the other post is an Export.
2. The Import and Export post must both be in status of POST. The Import and Export Ramp Location must be an exact match OR be a suitable replacement from the Location match table.
3. The Import and Export Steamship Line must be an exact match OR one of the suitable replacements from the Shipping Line Match table.
4. Import and Export Container Size must be an exact match OR one of the hardcoded substitutions.
5. The Import and Export date ranges (between Available Date/Tm and Expiration Date/Tm) must overlap each other.
6. Summary Posts—Allow matching on posts that are for more than one container or unit of demand.

As noted in the Background, the problems and issues in the conventional approaches for movement of standardized shipping containers that are desirably addressed by the system and method of the present disclosure may also impact other forms of containerized and standardized container movement of goods. These other forms of containerized movement of goods may include but are not limited to:
Container chassis
Rail vehicle transportation
Automotive industry logistics
Oil and gas logistics
FMCG pooling
Pallet returns
Domestic big box and intermodal
Container/trailer planning and pooling

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A transportation coordination method comprising:
providing a plurality of exporters with each exporter having items needing to be shipped in at least one standardized shipping container, with each of these exporters having at least one specific location of destination where their items are located and specifying a need for a particular type of standardized shipping container and a range of dates within which the at least one standardized shipping container is needed;
providing a plurality of importers with each importer having at least one standardized shipping container in which the importer received items, with each standardized shipping container being located at a specific location of origin and available for movement on a range of dates and being defined as a particular type of standardized shipping container;
providing each standardized shipping container in the possession of each of the importers belonging to an equipment owner;
compiling a list of the locations of destination where exporters need to have standardized shipping containers and the particular type of standardized shipping container needed at those locations of destination;
compiling a list of the locations of origin where importers have standardized shipping containers and the particular type of standardized shipping containers at those locations of origin;
defining compatible types of standardized shipping containers;
comparing the proximity of specific exporters needing standardized shipping containers within specific date ranges and specific importers having compatible standardized shipping containers available within those date ranges;
developing an initial global solution through the use of a Gale and Shapely algorithm with a schedule of container movements listing transportation of compatible standardized shipping containers from an importer within the range of dates specified by the importer to an exporter within the range of dates specified by the exporter so that the movement of transportation vehicles and standardized shipping containers will optimize the efficiency of standardized shipping container movements and the number of standardized shipping containers returned to any container yard empty;
communicating the scheduled container movements to each of the equipment owners, importers and exporters affected by the scheduled container movements on the initial global solution.

2. The method of claim 1, further comprising:
providing a plurality of equipment owners, with each equipment owner owning one or more of the standardized shipping containers in the possession of the importers and each equipment operating out of at least one origin and at least one destination;
defining compatible equipment owners whose standardized shipping containers may be interchanged with standardized shipping containers of other equipment owners, so that compatible standardized shipping containers available for exporters may come from any of the compatible equipment owners;
developing an initial global solution through the use of the Gale and Shapely algorithm with the schedule of container movements listing transportation of compatible standardized shipping containers from importers to exporters within the date range specified by the exporters so that the movement of transportation vehicles and standardized shipping containers will optimize the efficiency of standardized shipping container movements and the number of standardized shipping containers returned to any container yard empty;
communicating the scheduled container movements to the plurality of equipment owners, importers and exporters affected by the scheduled container movements in the initial global solution.

3. The method of claim 1, further comprising:
after the initial global schedule with the schedule for movement of standardized shipping containers has been developed but before the movements has been executed, allowing each of the equipment owners, exporters and importers to review and adjust any of the scheduled container movements based on their specific business needs to create a revised global solution with a revised schedule for the movement of the standardized shipping containers, and communicating this revised schedule of movement to each of the affected equipment owners, exporters, importers, steamship lines and operators.

4. The method of claim 1, further comprising:
providing a plurality of ports at which the standardized shipping containers may be moved from ship to shore and shore to ship, with each equipment owner operating out of at least one of the ports;
defining the importers and exporters that are compatible with each port based on the equipment owner operating at each port;
developing the initial global solution through the use of the Gale and Shapely algorithm with the schedule of container movements from importers to exporters of compatible standardized shipping containers within the date ranges specified by the exporters so that the movement of standardized shipping containers will optimize the efficiency of standardized shipping container movements and the number of standardized shipping containers returned to any container yard empty.

5. The method of claim 1, further comprising the optimization of the global solution based on one of reduction of total aggregate distance of movement by standardized shipping containers, maximizing total distance of movements by standardized shipping containers saved as compared to other methods of scheduling movement, maximizing in-route transportation of standardized shipping containers, minimizing time of travel of standardized shipping containers during movement, and ensuring that time of delivery requirements for standardized shipping containers are strictly met.

6. A transportation coordination method comprising:
providing a plurality of exporters with each exporter having items needing to be shipped in standardized shipping containers, with each of these exporters having at least one specific location of destination where their items are located and specifying a need for a particular type of standardized shipping container and a date range within which the container is needed;
providing a plurality of importers with each importer having at least one standardized shipping container in which the importer received items, with each standardized shipping container being located at a specific location of origin within a date range and being defined by particular type of standardized shipping container;
providing each standardized shipping container in the possession of each of the importers belonging to an equipment owner;
compiling a list of the locations of destination where exporters need to have standardized shipping containers and the particular type of standardized shipping container needed at those locations;
compiling a list of the locations of origin where importers have standardized shipping containers and the particular type of standardized shipping containers at those locations;
defining compatible types of standardized shipping containers;
comparing the proximity of specific exporters needing standardized shipping containers within specific date ranges and specific importers having compatible standardized shipping containers available within those date ranges;
developing an initial global solution through the use of the Gale and Shapely algorithm with a schedule of container movements listing transportation of compatible standardized shipping containers from an importer within the range of dates specified by the importer to an exporter within the range of dates specified by the exporter so that the movement of transportation vehicles and standardized shipping containers will optimize the efficiency of standardized shipping container movements and the number of standardized shipping containers returned to any container yard empty;
communicating the scheduled container movements to each of the equipment owners, importers and exporters affected by the scheduled container movements on the initial global solution.

7. A transportation coordination system comprising:
a plurality of exporters with each exporter having items needing to be shipped in at least one standardized shipping container, with each of these exporters having a location of destination where their items are located, a need for a particular type of standardized shipping container and a range of dates within which the at least one standardized shipping container is needed;
a plurality of importers with each importer having at least one standardized shipping container, with each standardized shipping container at a location of origin, available for movement on a range of dates and being defined as a particular type of standardized shipping container;
each standardized shipping container belonging to an equipment owner;
a customer entry portal configured so that each exporter may enter the location of destination where the exporter needs to have a standardized shipping container, the date range when the standardized shipping container is needed and the particular type of standardized shipping container needed at that location of destination;
the customer entry portal also configured so that each importer may enter the locations of origin where the importer has a standardized shipping container, the date range when the standardized shipping container is available and the particular type of standardized shipping containers at that location of origin;
a compatibility table listing compatible types of standardized shipping containers;
a matching unit configured to compare the proximity of specific exporters needing standardized shipping containers within date ranges and specific importers having compatible standardized shipping containers available within those date ranges;
the matching unit configured to utilize the comparison of importer and exporter locations, container needs and dates and develop an initial global solution through the use of a Gale and Shapely algorithm with a schedule of container movements listing transportation of compatible standardized shipping containers from an importer within the range of dates specified by the importer to an exporter within the range of dates specified by the exporter so that the movement of transportation vehicles and standardized shipping containers will optimize the efficiency of standardized shipping container movements and the number of standardized shipping containers returned to any container yard empty;
a communication unit for communicating the scheduled container movements to each of the equipment owners, importers and exporters affected by the scheduled container movements on the initial global solution.
